(19) United States
(12) Patent Application Publication
(10) Pub. No.: US 2013/0048700 A1
(43) Pub. Date: Feb. 28, 2013

(54) FILLER METAL CHEMISTRY FOR IMPROVED WELDABILITY OF SUPER ALLOYS

(71) Applicants: Yan Cui, Greer, SC (US); Srikanth Chandrudu Kottilingam, Simpsonville, SC (US); Dechao Lin, Greer, SC (US); Brian Lee Tollison, Honea Path, SC (US)

(72) Inventors: Yan Cui, Greer, SC (US); Srikanth Chandrudu Kottilingam, Simpsonville, SC (US); Dechao Lin, Greer, SC (US); Brian Lee Tollison, Honea Path, SC (US)

(73) Assignee: GENERAL ELECTRIC COMPANY, Schenectady, NY (US)

(21) Appl. No.: 13/219,993

(22) Filed: Aug. 29, 2011

(51) Int. Cl. B23K 31/00; C22C 30/00; C22C 19/05

(52) U.S. Cl. 228/101; 420/450; 420/586

(57) ABSTRACT

A filler metal chemistry includes an amount of chromium weight of between about 9.0% and about 16% by weight, an amount of cobalt of between about 7.0% and about 14% by weight, an amount of molybdenum of between about 10% and about 20% by weight, an amount of iron of between about 1.0% and about 5.0% by weight, an amount of aluminum of between about 0.05% and about 0.75% by weight, an amount of titanium of between about 0.5% and about 2.0% by weight, an amount of manganese not to exceed 0.8% by weight, an amount of carbon of between 0.02% and about 0.10% by weight, an amount of titanium+aluminum of between about 0.55% and 2.75% by weight, and an amount of nickel.

### BACKGROUND OF THE INVENTION

The subject matter disclosed herein relates to the art of metal joining and, more particularly, to a filler rod metal chemistry for joining components.

High strength and oxidation resistant alloys such as nickel-based super alloys are widely used in the construction of turbomachines. Super alloys possess strength, weight, durability, and temperature properties desirable for use in many turbomachine components. However, in general, super alloys have poor fusion weldability due to a tendency for liquation cracking and strain age cracking (SAC). SAC is closely related to gamma prime volume fraction, which is a function of Aluminum (Al) and titanium (Ti) content. An increase in the gamma prime fraction and, in particular Al content, increases the tendency for SAC. SAC generally occurs in a weld metal adjacent to a fusion boundary (WMATFB) region and/or propagates into a heat-affected zone (HAZ) of a base metal. Material in the WMATFB region includes base metal resulting from dilution and filler metal added during welding. As such, the WMATFB region should include a chemistry that falls within a weldable material region to avoid, or at least lower, a tendency towards SAC.

If the WMATFB region chemistry falls within the weldable material region, cracking tendency is low. In a tungsten inert gas (TIG) welding process for example, a typical dilution ratio is about 30:70 which means 30% of the WMATFB region includes base metal and 70% of the WMATFB region includes filler metal. Accordingly, filler metal for welding a particular alloy should possess certain chemical composition and mechanical properties at elevated temperatures.

### BRIEF DESCRIPTION OF THE INVENTION

According to one aspect of the exemplary embodiment, a filler metal chemistry includes an amount of chromium weight of between about 9.0% and about 16% by weight, an amount of cobalt of between about 7.0% and about 14% by weight, an amount of molybdenum of between about 10% and about 20% by weight, an amount of iron of between about 1.0% and about 5.0% by weight, an amount of aluminum of between about 0.05% and about 0.75% by weight, an amount of titanium of between about 0.5% and about 2.0% by weight, an amount of manganese not to exceed 0.8% by weight, an amount of carbon of between 0.02% and about 0.10% by weight, an amount of titanium+aluminum of between about 0.55% and 2.75% by weight, and an amount of nickel.

According to another aspect of the exemplary embodiment, a method of joining metals includes joining a first alloy to a second alloy using a filler metal including an amount of chromium of between about 9.0 and about 16% by weight, an amount of cobalt by weight of between about 7.0% and about 14% by weight, an amount of molybdenum of between about 10% and about 20% by weight, an amount of iron of between about 1.0% and about 5.0% by weight, an amount of aluminum of between about 0.05% and about 0.75% by weight, an amount of titanium of between about 0.5% and about 2.0% by weight, an amount of manganese not to exceed 0.8% by weight, an amount of carbon of between 0.02% and about 0.10% by weight, an amount of titanium+aluminum of between about 0.55% and 2.75% by weight, and an amount of nickel.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a partial cross-sectional view of a substrate having a cavity filled with filler metal in accordance with the prior art;

FIG. 2 is a partial cross-sectional view of a substrate having a cavity filled with another filler metal of the prior art; and

FIG. 3 is a partial cross-sectional view of a substrate having a cavity filled with a filler metal in accordance with an exemplary embodiment.

The detailed description explains embodiments of the invention, together with advantages and features, by way of example with reference to the drawings.

### DETAILED DESCRIPTION OF THE INVENTION

Substrates, particularly surfaces of turbomachinery, develop pits, cavities and the like. Impurities carried by inlet air, or developed by combustion pass through various portions of a turbomachine. The impurities often times become deposited on internal turbomachine surfaces and, over time, eventually form pits, cavities or the like. Other impurities may create cavities or pits by impacting the internal surfaces at high velocity. If the size of the cavity or pit exceeds a desired threshold, the substrate must be repaired or replaced. Repairing the substrate is desirable due to the high cost of turbomachine components.

Previously, cavities and/or pits having a diameter greater than about 0.250″ were considered unrepairable. Current filler metal chemistry, limits repair to cavities under 0.250″. Cavities over 0.250″ could not be properly repaired without experiencing cracks that could lead to component failure or turbomachine damage. For example, as shown in FIG. 1, a substrate 2 includes a cavity 4 having a diameter of approximately 0.54″. Cavity 4 is filled with a prior art filler metal 6 which, in the exemplary embodiment shown, takes the form of a super alloy H230. Poor fusion weldablity between filler metal 6 and substrate 2 resulted in strain age cracking (SAC). The SAC occurred in filler metal 6 adjacent to a weld metal fusion boundary (WMATFB) region or the region between filler metal 6 and substrate 2. As shown, the SAC resulted in the formation of cracks 9 and 11 having a length that exceeds desired parameters. Cracks of such magnitude could result in filler metal 6 becoming dislodged from cavity 4. If dislodged, filler metal 6 may cause damage to turbomachine components.

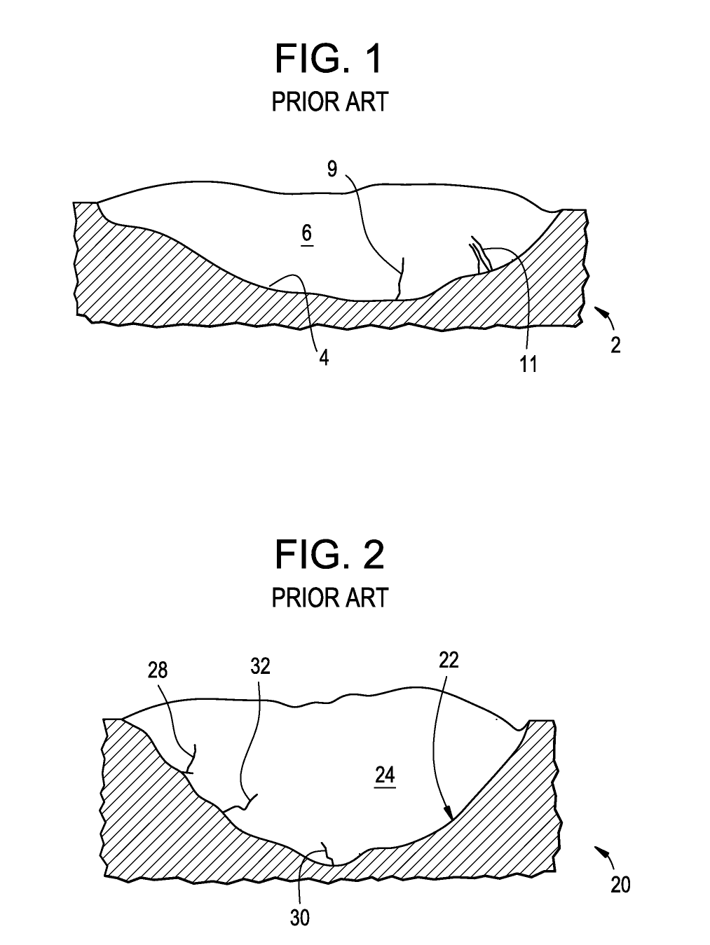

FIG. 2 illustrates a substrate 20 including a cavity 22 having a diameter of approximately 0.50″. Cavity 22 is filled with another prior art filler metal, which, in the exemplary embodiment shown, takes the form of Nimonic C263. Once again, poor fusion weldability between filler metal 24 and substrate 20 resulted in strain age cracking (SAC). The SAC occurred in filler metal 24 adjacent to the WMATFB region. Additional cracking may also occur in other regions of filler metal 24 as a result of SAC. As shown, the SAC resulted in the formation of cracks 28, 30, and 32. Crack 28 has a length of approximately 0.041″, crack 30 has a length of approximately 0.032″, and crack 32 has a length of approximately 0.56″. Cracks 28, 30, and 32 exceed desired crack length limits. In a manner similar to that described above, cracks of such magnitude could result in filler metal 24 becoming dislodged from cavity 22.

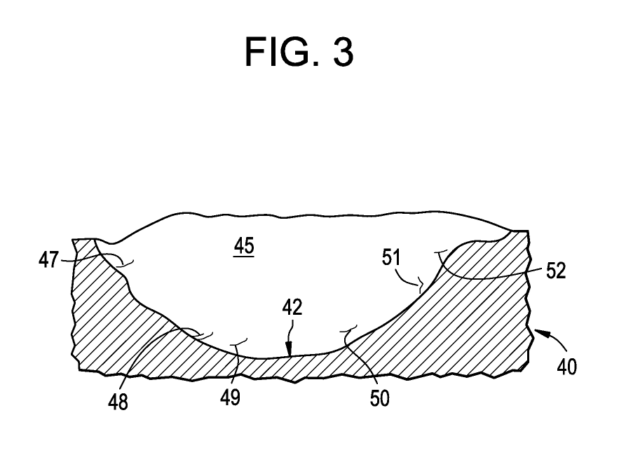

FIG. 3 illustrates a substrate 40 having a cavity 43 that is approximately 0.50″ in diameter. Cavity 43 is filled with a filler metal 45 having a filler metal chemistry in accordance with an exemplary embodiment. Filler metal 45 is resistant to SAC. That is, while filler metal 45 does exhibit a number of cracks 47-52, each crack 47-52 is substantially smaller than the desired crack length limit. For example, crack 47 is approximately 0.020″ in length, crack 48 is approximately 0.010″ in length, crack 49 is approximately 0.014″ in length, crack 50 is approximately 0.010″ in length, crack 51 is approximately 0.012″ in length, and crack 52 is approximately 0.008″ in length. Experience has shown that such cracks are less likely to lead to filler metal failure. As such, filler metal 45 can be employed to repair cavities that were previously considered unrepairable using conventional methods and filler metals.

In accordance with the exemplary embodiment, filler metal 45 includes a filler metal chemistry having an amount of chromium of between about 9.0 and about 16% by weight, an amount of cobalt of between about 7.0% and about 14% by weight, an amount of molybdenum of between about 10% and about 20% by weight, an amount of iron of between about 1.0% and about 5.0% by weight, an amount of aluminum of between about 0.05% and about 0.75% by weight, an amount of titanium of between about 0.5% and about 2.0% by weight, an amount of manganese not to exceed 0.8% by weight, an amount of carbon of between 0.02% and about 0.10% by weight, an amount of titanium+aluminum of between about 0.55% and 2.75% by weight, and the remainder including an amount of nickel.

In accordance with one aspect of the exemplary embodiment, the amount of chromium is between about 11% and about 14% by weight, the amount of cobalt is between about 10% and about 11% by weight, the amount of molybdenum is between about 14% and about 16% by weight, the amount of iron is between about 2.0% and about 4.0% by weight, the amount of aluminum is between about 0.15% and about 0.3% by weight, the amount of titanium is between about 1.0% and about 1.2% by weight, the amount of carbon is between 0.02% and about 0.10% by weight, and the amount of titanium+aluminum is between about 1.2% and 1.4% by weight, with the remainder including an amount of nickel.

In accordance with another aspect of the exemplary embodiment the amount of chromium is about 12.5% by weight, the amount of cobalt is about 10.5% by weight, the amount of molybdenum is about 15.0% by weight, the amount of iron is about 3.0% by weight, the amount of aluminum is about 0.25% by weight, the amount of titanium is about 1.1% by weight, the amount of carbon is about 0.06% by weight, and the amount of titanium+aluminum is about 1.65% by weight with the remainder including an amount of nickel.

The particular filler metal chemistry for filler metal 45 allows for the repair cavities, pits etc that are larger than were previously possible. More specifically, the particular filler metal chemistry has been shown to exhibit acceptable strength, wear and adhesion properties when used to repair cavities of up to 1″ or more in diameter. By allowing for repair of larger cavities, pits etc, the particular filler metal chemistry allows for the repair and re-use of turbomachine components that would previously have been discarded. Thus, the particular filler metal chemistry leads to a substantial cost savings. At this point it should be understood that while discussed in terms of the repair of turbomachinery, the particular filler metal chemistry can be used to repair a wide array of components. That is, filler metal 45 is compatible with a wide range of materials such as steels, stainless steels and other super alloys such as GTD111™, GTD444™ and R108™. That is, the filler metal in accordance with the exemplary embodiment can be employed to join a first member formed stainless steel with a second member formed from stainless steel. The filler metal in accordance with the exemplary embodiment can likewise be employed to join a first member formed from a super alloy including one of GTD111™, GTD444™ and R108™, with second member formed from a super alloys including one of GTD111™, GTD444™, and R108™.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A filler metal chemistry comprising:
an amount of chromium of between about 9.0 and about 16% by weight;
an amount of cobalt by weight of between about 7.0% and about 14% by weight;
an amount of molybdenum of between about 10% and about 20% by weight;
an amount of iron of between about 1.0% and about 5.0% by weight;
an amount of aluminum of between about 0.05% and about 0.75% by weight;
an amount of titanium of between about 0.5% and about 2.0% by weight;
an amount of manganese not to exceed 0.8% by weight;
an amount of carbon of between 0.02% and about 0.10% by weight;
an amount of titanium+aluminum of between about 0.55% and 2.75% by weight; and
an amount of nickel.

2. The filler metal chemistry according to claim 1, wherein the amount of chromium is between about 11% and about 14% by weight.

3. The filler metal chemistry according to claim 2, wherein the amount of chromium is about 12.5% by weight.

4. The filler metal chemistry according to claim 1, wherein the amount of cobalt is between about 10% and about 11% by weight.

5. The filler metal chemistry according to claim 4, wherein the amount of cobalt is about 10.5% by weight.

6. The filler metal chemistry according to claim 1, wherein the amount of molybdenum is between about 14% and about 16% by weight.

7. The filler metal chemistry according to claim 6, wherein the amount of molybdenum is about 15.0% by weight.

8. The filler metal chemistry according to claim 1, wherein the amount of iron is between about 2.0% and about 4.0% by weight.

9. The filler metal chemistry according to claim 8, wherein the amount of iron is about 3.0% by weight.

10. The filler metal chemistry according to claim 1, wherein the amount of aluminum is between about 0.15% and about 0.3% by weight.

11. The filler metal chemistry according to claim 10, wherein the amount of aluminum is about 0.25% by weight.

12. The filler metal chemistry according to claim 1, wherein the amount of titanium is between about 1.0% and about 1.2% by weight.

13. The filler metal chemistry according to claim 12, wherein the amount of titanium is about 1.1% by weight.

14. The filler metal chemistry according to claim 1, wherein the amount of carbon is between 0.02% and about 0.10% by weight.

15. The filler metal chemistry according to claim 14, wherein the amount of carbon is about 0.06% by weight.

16. The filler metal chemistry according to claim 1, wherein the amount of titanium+aluminum is between about 1.2% and 1.4% by weight.

17. The filler metal chemistry according to claim 16, wherein the amount of titanium+aluminum is about 1.65% by weight.

18-20. (canceled)
